(19) United States
(12) Patent Application Publication
(10) Pub. No.: US 2007/0188793 A1
(43) Pub. Date: Aug. 16, 2007

(54) INFORMATION PROCESSING APPARATUS AND METHOD AND PROGRAM OF CONTROLLING AN INFORMATION PROCESSING APPARATUS

(75) Inventor: Masanori Wakai, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/668,658

(22) Filed: Jan. 30, 2007

(30) Foreign Application Priority Data
Feb. 9, 2006 (JP) 2006-032503

(51) Int. Cl. G06K 15/00

(52) U.S. Cl. 358/1.14; 382/119

(57) ABSTRACT

An information processing apparatus includes a scanning unit adapted to scan a document on which a signature is handwritten, a handwritten signature extraction unit adapted to extract the handwritten signature from the scanning unit, a handwritten signature authentication unit adapted to authenticate the handwritten signature extracted by the extraction unit, based on authentication information, and a permission unit adapted to, if the handwritten signature is successfully authenticated by the handwritten signature authentication unit, grant permission of a process on the scanned document.

### BACKGROUND OF THE INVENTION

1. Field of the Invention

The present invention relates to an information processing apparatus and a method and program of controlling an information processing apparatus, capable of authenticating a document having a signature handwritten thereon.

2. Description of the Related Art

Nowadays, an information processing apparatus is widely used which is capable of performing a process, in accordance with a command issued by a user, on document data acquired by scanning data using a scanner, a digital camera or the like. For example, in a typical multifunction apparatus having a scanner function, a printer function, a facsimile function, etc., it is possible to transmit a scanned document via mail in accordance with a command issued by a user. In such a multifunction apparatus, it is known to protect an important document from an unauthorized operation, by allowing the document to be processed only when authentication is successful. It is also known to perform a process in a highly efficient manner using information included in a scanned document.

For example, Japanese Patent Laid-Open No. 11-003353 discloses a technique to embed original information such as text or audio data of a description of a document and attribute information including authentication information in the document whereby the original information is allowed to be reproduced only when authentication information input by a user is identical to the embedded authentication information.

Japanese Patent Laid-Open No. 2005-157447 discloses a technique in which only when a password input by a user is successfully authenticated, it is allowed to search for an original document corresponding to a scanned document and extract differences between the original document and the scanned document. In this technique, the difference information is managed in connection with the original document.

However, in these techniques disclosed in the patent documents cited above, an authentication operation is performed on an operation screen, and thus operations are possible only for a person who knows his/her password.

In view of the above, the present invention provides a technique that allows a person, who does not know a password, to perform an operation that needs authentication by scanning a document on which a signature is written by hand whereby it is possible to achieve high security.

### SUMMARY OF THE INVENTION

According to an aspect of the present invention, an information processing apparatus includes a scanning unit adapted to scan a document on which a signature is handwritten, a handwritten signature extraction unit adapted to extract the handwritten signature from the scanning unit, a handwritten signature authentication unit adapted to authenticate the handwritten signature extracted by the extraction unit, based on authentication information, and a permission unit adapted to, if the handwritten signature is successfully authenticated by the handwritten signature authentication unit, grant permission of a process on the scanned document.

According to another aspect of the present invention, a method of controlling an information processing apparatus, includes scanning a document on which a signature is handwritten, extracting the handwritten signature from the scanned document, authenticating the handwritten signature extracted, based on authentication information, and if the handwritten signature is successfully authenticated, granting permission of a process on the scanned document.

According to another aspect of the present invention, a computer program readable and executable by an information processing apparatus includes scanning a document on which a signature is handwritten, extracting the handwritten signature from the scanned, authenticating the handwritten signature extracted, based on authentication information, and if the handwritten signature is successfully authenticated, granting permission of a process on the scanned document.

According to another aspect of the present invention, a method of controlling an information processing apparatus includes scanning a document on which a signature is handwritten, extracting the handwritten signature from the scanned document, and granting permission of a process on the scanned document, in accordance with a result of authentication performed, based on authentication information, for the handwritten signature extracted.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing a hardware configuration of an information processing apparatus according to an embodiment of the present invention.

FIG. 2 shows an example of a manner in which an information processing apparatus is operated according to an embodiment of the present invention.

FIG. 3 shows an example of a functional block configuration of an information processing apparatus according to an embodiment of the present invention.

FIG. 4 shows an overview of processes associated with respective functions according to an embodiment of the present invention.

FIG. 5 is a diagram showing an example of an operation command input screen according to an embodiment of the present invention.

FIG. 6 is a flow chart showing a general process according to an embodiment of the present invention.

FIG. 7 is a flow chart showing a scanning process according to an embodiment of the present invention.

FIG. 8 is a flow chart showing a handwritten signature extraction process according to an embodiment of the present invention.

FIG. 9 shows an example of a document restricted in terms of processes performed thereon.

FIG. 10 is a flow chart showing a process of granting permission of a process on a document restricted in terms of processes performed thereon.

FIG. 11 shows an example of a document in which handwritten signature identification data is embedded according to an embodiment of the present invention.

FIG. 12 shows an example of a handwritten signature authentication registration database according to an embodiment of the present invention.

FIG. 13 is a flow chart showing a handwritten signature authentication process according to an embodiment of the present invention.

FIG. 14 is a flow chart showing a process of executing an operation specified by an input command according to an embodiment of the present invention.

FIG. 15 is a flow chart showing a process of acquiring online handwritten signature authentication data according to an embodiment of the present invention.

FIG. 16 is a flow chart showing an online handwritten signature authentication process according to an embodiment of the present invention.

FIG. 17 shows an example of an online handwritten signature authentication registration database according to an embodiment of the present invention.

FIG. 18 shows an example of a rule of necessity of second authentication according to an embodiment of the present invention.

FIG. 19 is a flow chart showing a process of executing an operation specified by an input command according to an embodiment of the present invention.

FIG. 20 is a flow chart showing a second authentication necessity determination process according to an embodiment of the present invention.

FIG. 21 shows an example of a second authentication necessity rule registration screen according to an embodiment of the present invention.

FIG. 22 is a flow chart showing a second authentication necessity rule registration process according to an embodiment of the present invention.

FIG. 23 is a flow chart showing an online handwritten signature registration process according to an embodiment of the present invention.

FIG. 24 shows an example of a document in which a handwritten signature written on the document is embedded according to an embodiment of the present invention.

FIG. 25 is a flow chart showing a handwritten signature embedding process according to an embodiment of the present invention.

### DESCRIPTION OF THE EMBODIMENTS

Exemplary embodiments of the present invention will now be described in detail in accordance with the accompanying drawings.

Note that the purpose of the embodiments described below is not to limit the invention. All parts, elements, or steps described in embodiments are not necessarily needed to practice the invention.

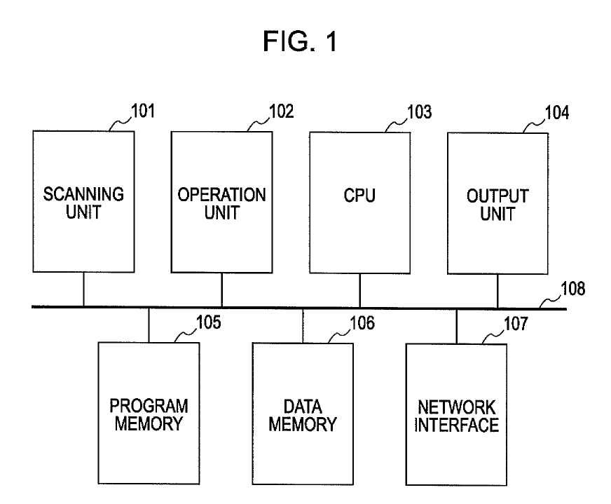

FIG. 1 is a block diagram showing a hardware configuration of an information processing apparatus according to an embodiment of the present invention. In FIG. 1, reference numeral 101 denotes a scanning unit for scanning a document. Reference numeral 102 denotes an operation unit for inputting a command such as a scan command, an output command, etc. via an operation panel or a key pad. Reference numeral 103 denotes a CPU that performs various processes, calculations, logical decisions, etc., and controls various units connected to a bus 108. Reference numeral 104 denotes an output unit that outputs data in a printed form. Reference numeral 105 denotes a program memory in which a program is stored which is executed by the CPU 103 to perform various processes including procedures which will be described later with reference to flow charts. The program memory 105 may be a ROM or a RAM in which the program is loaded from an external storage device. Reference numeral 106 denotes a data memory for storing data occurring in various kinds of processes. The data memory 106 may be realized, for example, by a RAM. Data may be loaded in advance into the RAM from a nonvolatile external storage medium or may be loaded therein whenever data is needed. Reference numeral 107 denotes a network interface for transmitting or receiving data to or from an external device via a network. The bus transmits, from the CPU 2 to the units, address signals indicating units to be controlled by the CPU 2 and control signals by which to control the units. The bus 108 is also used to transfer data among the units. The information processing apparatus may further include other units, for example, a display such as an LCD or a CRT.

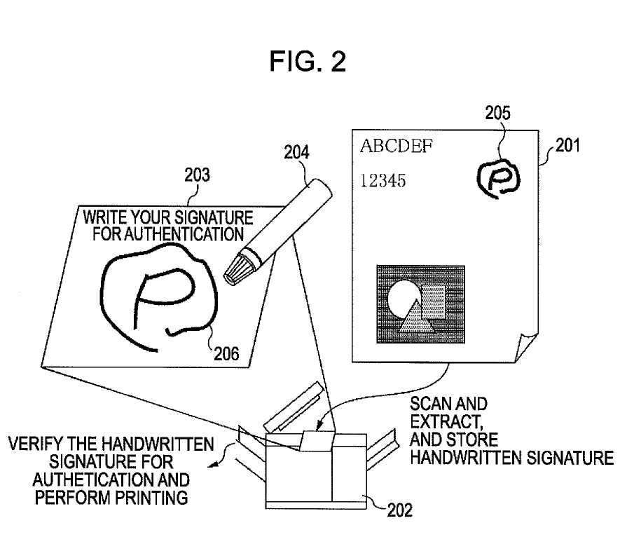

FIG. 2 shows an example of a manner in which the information processing apparatus is operated according to the present embodiment. In the present embodiment, it is assumed by way of example that the information processing apparatus shown in FIG. 1 is a multifunction apparatus 202. Note that other types of apparatuses may be used as the information processing apparatus, as long as the present invention can be practiced. As shown in FIG. 2, a document 201 on which a signature 205 is handwritten is scanned by the multifunction apparatus 202. In a specific example, the signature 205 is handwritten on the document 201 by a superior at a desk in an office, and the document is handed to a subordinate. If the subordinate carries the received document 201 to the multifunction apparatus 202 and performs an operation on the multifunction apparatus 202 to make a copy of the document, the multifunction apparatus 202 authenticates the handwritten signature. If the authentication is successful, copying of the document is performed. As will be described later, a handwritten signature (an online handwritten signature 206) may be directly input to the multifunction apparatus 202 by handwriting the signature on the operation panel 203 of the multifunction apparatus 202 by using a pen 204, and the multifunction apparatus 202 may authenticate the input online handwritten signature. Hereinafter, paper documents will be referred to simply as documents, and documents obtained by scanning paper documents will be referred to simply as scanned documents. Each document may include only one page or a plurality of pages.

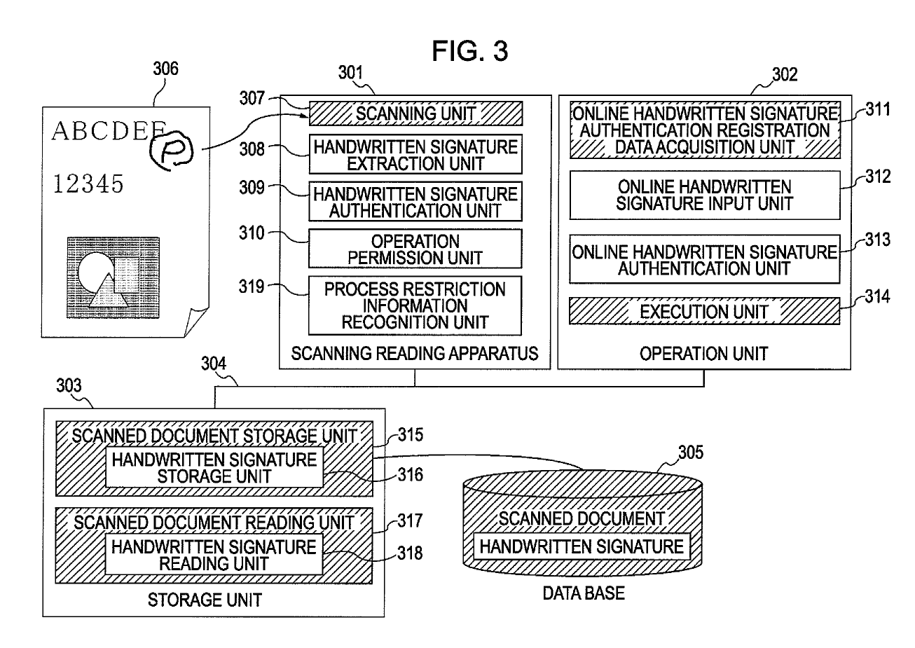

FIG. 3 shows an example of a functional block configuration of the information processing apparatus according to the present embodiment. As shown in FIG. 3, main parts of the information processing apparatus are a scanning apparatus 301, an operation unit 302, and a storage unit 303. First, a document 306 is scanned by a scanning unit 307. Next, the handwritten signature on the document is extracted by a handwritten signature extraction unit 308 and authenticated by a handwritten signature authentication unit 309. Depending on an authentication result, an operation permission unit 310 grants permission of an operation on the scanned document. If the operation is permitted, the scanned document is sent to the storage unit 303 via a bus 304. If the storage unit 303 receives the scanned document, the scanned document is stored in a scanned document storage unit 315 and the signature is stored in handwritten signature storage unit 316. Note that the storage unit 303 also includes a scanned document reading unit 317 for reading the scanned document and a handwritten signature reading unit 318 for reading the signature. As will be described later, the storage unit 303 may further include a process restriction information recognition unit 319 for recognizing a restriction on the process on the scanned document, whereby if the process restriction information recognition unit 319 recognizes that there is a restriction on the process on the scanned document, the process on the scanned document may be restricted.

In the operation unit 302, a process to be executed on the authenticated scanned document is specified, and the specified process is executed by an execution unit 314. Specific examples of processes include printing, transmitting, displaying, and document searching. As will be described later with reference to an alternative embodiment, the operation unit 302 may further include an online handwritten signature registration data acquisition unit 311, an online handwritten signature input unit 312, and an online handwritten signature authentication unit 313, for authenticating the online handwritten signature. In this case, the online handwritten signature registration data acquisition unit 311 acquires online handwritten signature registration data corresponding to the handwritten signature stored, together with the scanned document, in the storage unit 303. If a handwritten signature is input on line using the online handwritten signature input unit 312, the online handwritten signature registration data acquisition unit 311 acquires the online handwritten signature registration data corresponding to the input handwritten signature and the online handwritten signature authentication unit 313 authenticates the input handwritten signature. If the authentication is successful, the execution unit 314 executes the process.

The bus 304 may be replaced with a network, and the processes described above may be performed by separate apparatuses on the network. Furthermore, the functions of each unit may be implemented by separate devices connected via a network. For example, the handwritten signature authentication unit 309 may be realized by an external device. In this case, the information processing apparatus transmits the handwritten signature extracted by the handwritten signature extraction unit 308 to the external device serving as the handwritten signature authentication unit 309. If an authentication result is returned from the external device serving as the handwritten signature authentication unit 309, the operation permission unit 310 grants permission of an operation depending on the received authentication result.

The storage unit 303 stores the received scanned document and handwritten signature in connection with each other in a database 305. The stored scanned document and handwritten signature are read, as required, in response to an operation performed by a user. A printing unit performs printing in accordance with the data stored in the storage unit 303.

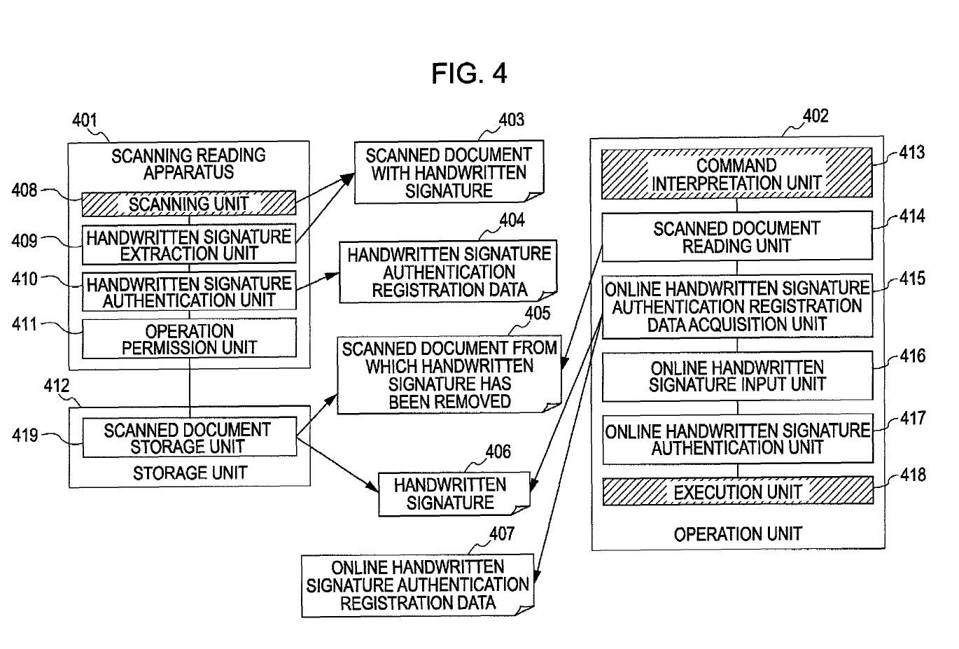

FIG. 4 shows an overview of processes associated with the respective functions according to the present embodiment of the invention described above with reference to FIG. 3. The functions are realized by cooperation of the program stored in the program memory 103 and the CPU 103. Note that all functions are not necessarily required in all embodiments described below, and functions other than those described above may be included in the embodiments.

First, processes performed by the scanning apparatus 401 (denoted by reference numeral 301 in FIG. 3) and the storage unit 412 (denoted by reference numeral 303 in FIG. 3) are described. The scanning unit 408 scans the document 403 on which a signature is handwritten. The handwritten signature extraction unit 409 extracts the handwritten signature from the scanned document. The handwritten signature authentication unit 410 compares the extracted handwritten signature with handwritten signature authentication registration data 404 to evaluate the similarity between the handwritten signature and the handwritten signature registration data. If it is determined that the similarity is high, the handwritten signature is affirmatively authenticated.

The operation permission unit 411 grants permission of an operation depending on the authentication result. If the permission of the operation is granted, a scanned document storage unit 419 stores the handwritten signature 406 and the scanned document 405 obtained by deleting the handwritten signature 406. Deleting of the handwritten signature makes it possible to print the scanned document in a form having no handwritten signature. Furthermore, this protects the handwritten signature, which should be kept secret, from undesirable exposure to third persons.

On the other hand, in the operation unit 402 (denoted by reference numeral 302 in FIG. 3), the following process is performed. If a command interpretation unit 413 receives a command input by a user, the command interpretation unit 413 interprets the input command. The execution unit 418 executes a process specified by the interpreted command on the scanned document 405.

In a case in which online handwritten signature authentication (which will be described later) is performed, the following process is performed. A scanned document reading unit 414 reads the scanned document from which the handwritten signature has been removed. An online handwritten signature registration data acquisition unit 415 acquires online handwritten signature registration data corresponding to the handwritten signature. If a handwritten signature is input online using an online handwritten signature input unit 416, an online handwritten signature authentication unit 417 authenticates the input online handwritten signature by comparing it with the handwritten signature registered in the online handwritten signature authentication registration data 407. The execution unit 418 executes the process depending on the authentication result.

When the document includes a plurality of pages, a signature is written by hand only on a first page, and a result of authentication of the handwritten signature on the first page is applied to the second and following pages. In this case, the operation unit 402 may further include a judgment unit to determine whether the second and following pages belong to the same document as the document to which the first page belongs, whereby only when it is determined that the second and following pages belong to the same document as that of the first page, the result of the authentication of the first page is applied to the second and following pages. Alternatively, a signature may be written by hand on all pages, and authentication may be performed separately for each of all the pages.

The information processing apparatus described above with reference to FIGS. 1 to 4 are described in further detail below with reference to specific embodiments.

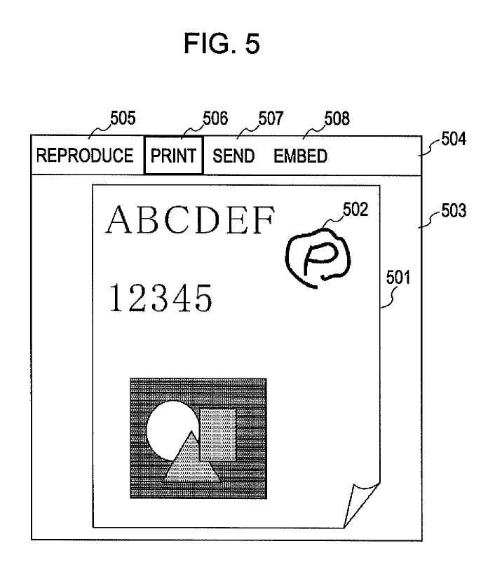

First, with reference to FIGS. 5 to 10, a first embodiment is described. In this first embodiment, a document having a handwritten signature is scanned, and a process that needs authentication is performed on the scanned document. In this embodiment, by way of example, it is assumed that an operation-restricted document treated herein is stamped “COPY PROHIBITED”, “FOR IN-COMPANY USE ONLY” or the like.

FIG. 5 shows an example of a display screen displayed on the operation panel 203 of the multifunction apparatus 202 according to the first embodiment. On the display screen 503, a scanned document 501 and a menu bar 504 are displayed. The scanned document 501 includes a handwritten signature 502 written thereon, and the menu bar 504 includes a “reproduce” button 505, a “print” button 506, a “send” button 507, and an “embed” button 508 for selecting a process to be executed. In the specific example shown in FIG. 5, the “print” button 506 on the menu bar 504 is selected.

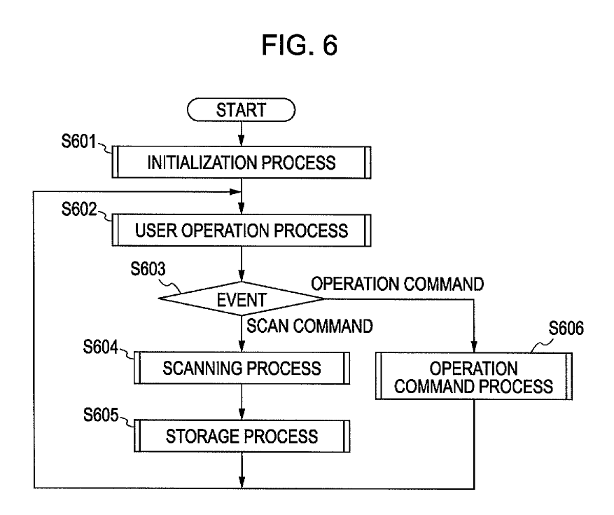

FIG. 6 is a flow chart showing a general process of the multifunction apparatus according to the first embodiment. First, in step S601, initialization is performed and an operation screen is displayed. Next, in step S602, a user performs an operation. In step S603, a determination is made as to what operation has been performed by the user. If it is determined in step S603 that a scan command has been input, then in step S604, a document is scanned. Furthermore, in step S605, the scanned document is stored. Thereafter, the processing flow returns to step S602 to repeat the process from step S602. If an operation command other than the scan command is issued in step S603, a process corresponding to the issued operation command is executed (step S606). Thereafter, the processing flow returns to step S602 to repeat the process from step S602.

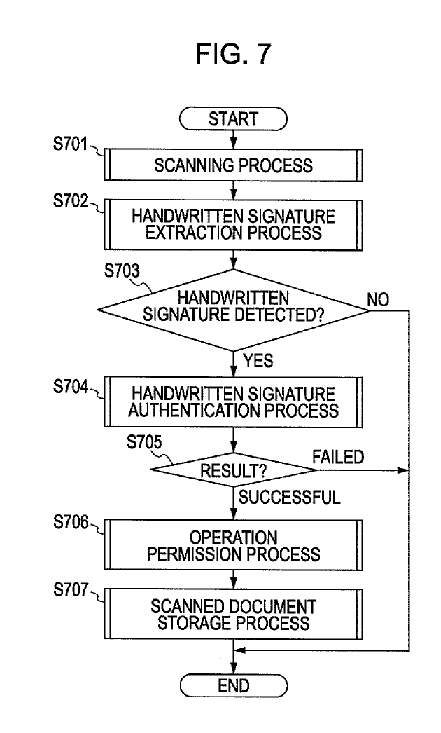

FIG. 7 is a flow chart showing the scanning process according to the first embodiment. First, in step S701, the document 501 shown in FIG. 5 is read. Next, in step S702, the handwritten signature (denoted by reference numeral 502 in FIG. 5) written on the scanned document is extracted. If it is determined in step S703 that the handwritten signature has been extracted, the process proceeds to step S704 to authenticate the handwritten signature. The authentication can be performed according to a known technique, and thus a further detailed explanation thereof is omitted herein. In this first embodiment, dictionary data indicating a handwritten signature of each of a plurality of users is stored as handwritten signature registration data 404 in the data memory 106, and the extracted handwritten signature is compared with the corresponding handwritten signature included in the handwritten signature registration data 404. If it is determined that these two have high similarity, the handwritten signature is affirmatively authenticated. Alternatively, the processes permitted to be performed may be changed depending on the similarity. In the handwritten signature registration data 404, in addition to the correspondence between handwritten signatures and users, processes permitted for respective users may also be described.

If it is determined in step S705 that the authentication is successful, then in step S706, permission of the operation is granted. Next, in step S707, the scanned document is stored together with the extracted handwritten signature, and the process is ended. In a case in which it is determined in step S703 that there is no handwritten signature or in a case in which it is determined in step S705 that the authentication is unsuccessful, the process is directly ended. Note that it is not necessarily needed to treat the handwritten signature registration data 404 in the above-described manner, for example, the handwritten signature registration data 404 may be stored at other locations via a network.

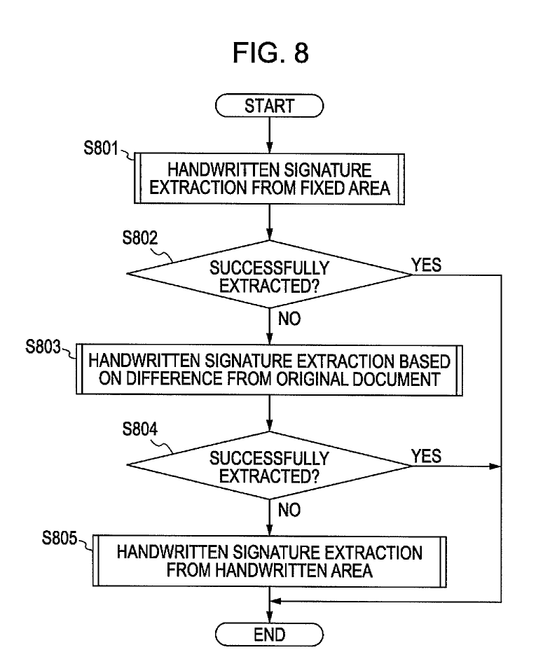

FIG. 8 is a flow chart showing the handwritten signature extraction process performed by the handwritten signature extraction unit 308 (FIG. 3) according to the first embodiment. First, in step S801, a handwritten signature is extracted from a predetermined handwritten-signature writing area according to a predetermined format. In step S802, a determination is made as to whether the handwritten signature has been successfully extracted. If it is determined in step S802 that the extraction of the handwritten signature is unsuccessful, the process proceeds to step S803. In step S803, the scanned document is compared with an original document corresponding to the scanned document to extract a handwritten signature. If it is determined in step S804 that the extraction of the handwritten signature is unsuccessful, the process proceeds to step S805. In step S805, a handwritten area is extracted from the scanned document including both printed text area and a handwritten area, and a handwritten signature is extracted from the handwritten area. If it is determined that the extraction is successful in step S802 or S804, the present process is ended. A plurality of documents including original documents may be stored in advance in the data memory or may be stored in a document server via a network interface. The method of the handwritten signature extraction is not limited to the above-described method, and the handwritten signature extraction may be performed by other methods. Either the handwritten signature extraction from the fixed area or the handwritten signature extraction based on detection of a difference from the original document may be performed earlier or later than the other.

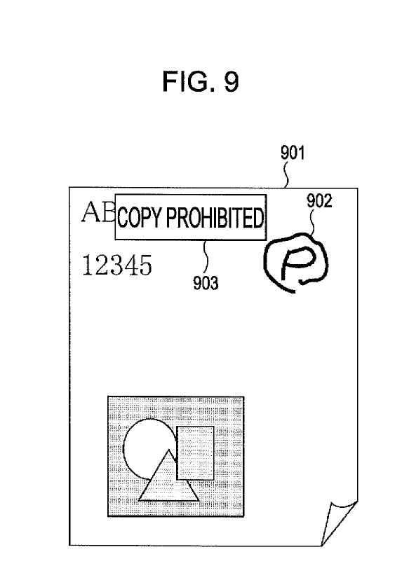

FIG. 9 shows an example of a document which should be restricted in terms of processes performed thereon. In this specific example, a document 901 is stamped “COPY PROHIBITED” 903, and a signature 902 is handwritten on the document 901.

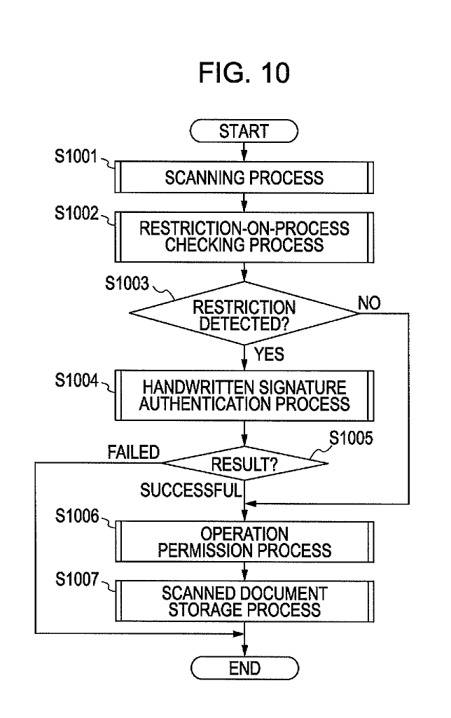

FIG. 10 is a flow chart showing a process of granting permission of a process on a document restricted in terms of processes performed thereon. In step S1001, the document 901 is scanned. In step S1002, a restriction-on-process recognition unit 319 checks whether a restriction on processes is defined for the scanned document. If it is determined in step S1003 that there is a restriction, then in step S1004, handwritten signature authentication is performed. If it is determined in step S1005 that the authentication is not successful, processing ends. On the other hand, if it is determined in step S1005 that the authentication is successful, then in step S1006, permission of a process is granted. In step S1007, the scanned document is stored. In a case in which no restriction is detected in step S1003, permission of the process is directly granted in step S1006 without performing the authentication of the handwritten signature.

Information indicating restricted processes and corresponding stamp information such as “COPY PROHIBITED”, “FOR IN-COMPANY USE ONLY”, “CONFIDENTIAL”, etc. and processes that are restricted are registered in advance, and in step S1002, restriction information is extracted from the scanned document to identify restricted processes.

In the present embodiment, as described above, by scanning a document having a handwritten signature, it becomes possible to allow a proxy who does not know a password for authentication to perform a process which needs authentication.

In the present embodiment, when processes allowed to be performed on the document are restricted, even a proxy, who is asked to perform an operation and who does not know a password, can perform an operation that needs authentication.

Now, a second embodiment is described. In this second embodiment, unlike the first embodiment described above, authentication is performed using a signature handwritten on a document and handwritten signature identification data embedded in advance in the document.

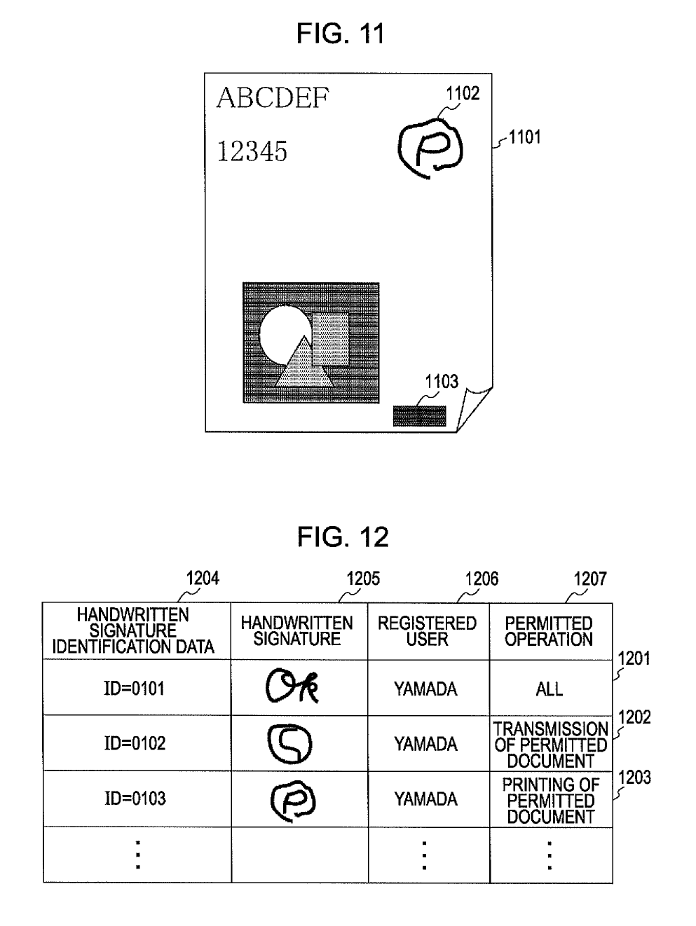

FIG. 11 shows an example in which a handwritten signature 1102 is written on a scanned document 1101 having embedded handwritten signature identification data. In this specific example, the handwritten signature identification data is printed in the form of a two-dimensional bar code 1103. Herein, it is assumed by way of example that data ID=0103 is printed as the handwritten signature identification data in the two-dimensional bar code.

FIG. 12 shows an example of a handwritten signature authentication registration database according to the second embodiment. In this example, data corresponding to ID=0101, ID=0102, and ID=0103 are stored in respective records 1201 to 1203 such that handwritten signature identification data is described in a field 1204 of each record, and a handwritten signature, a registered user, and a permitted operation are described in respective fields 1205, 1206, and 1207 in a record corresponding to the handwritten signature identification data.

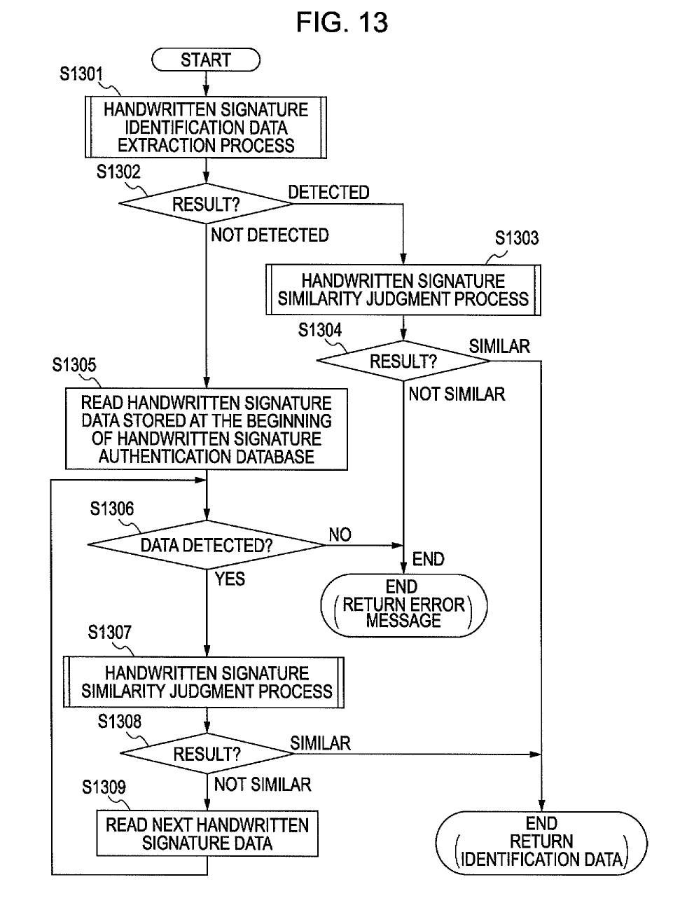

FIG. 13 is a flow chart showing a handwritten signature authentication process according to the second embodiment. First, in step S1301, handwritten signature identification data 1103 embedded in a scanned document is extracted. On the basis of the extracted identification data, the handwritten signature authentication registration database is searched for a corresponding handwritten signature image. If it is determined in step S1302 that handwritten signature identification data has been found, then in step S1303, similarity of the handwritten signature is checked. More specifically, in this step, the similarity of the handwritten signature written on the document is evaluated with respect to the handwritten signature image identified by the handwritten signature identification data within a predetermined tolerance. If it is determined in step S1304 that the similarity is high enough, the handwritten signature identification data is returned and the current process is ended. On the other hand, if it is determined in step S1304 that the similarity is low, a negative answer to the authentication is returned, and the current process is ended.

On the other hand, if it is determined in step S1302 that no handwritten signature identification data is detected, then in step S1305, first handwritten signature authentication data, that is, data described at the beginning of the handwritten signature authentication database is read. In step S1306, a determination is made as to whether data has been found. If it is determined in step S1306 that data has not been found, a negative answer to the authentication is returned, and the current process is ended. On the other hand, if it is determined in step S1306 that data has been found, then in step S1307, evaluation is performed as to the similarity of the handwritten signature written on the document with respect to the present data read from the handwritten signature authentication database within the predetermined tolerance. If it is determined in step S1308 that the similarity is high enough, corresponding handwritten signature identification data is returned and the current process is ended. On the other hand, if it is determined in step S1308 that the similarity is low, then in step S1309, next data is read from the handwritten signature authentication database, and the processing flow returns to step S1306 to repeat the process from step S1306.

In the example shown in FIG. 11, handwritten signature identification data is embedded as information 1103. Alternatively, handwritten signature registration data, from which it is possible to reproduce the handwritten signature, may be embedded as the information 1103. In this case, the similarity of the handwritten signature extracted from the document to the handwritten signature reproduced from the embedded data is evaluated, and the authentication is performed depending on the similarity.

A specific example of an operation according to the second embodiment is described below. If a document is set on the multifunction apparatus 202 and a read command is issued, the scanning unit 408 scans the document. After the scanning of the document by the scanning unit 408 is completed, the handwritten signature extraction unit 409 extracts a handwritten signature from the scanned document. Subsequently, the handwritten signature authentication unit 410 search the handwritten signature authentication registration database (FIG. 12) using the handwritten signature as a search key. If corresponding handwritten signature registration data 404 is found, the authentication is performed affirmatively. On the other hand, in the case in which the scanned document includes handwritten signature identification data (FIG. 11), the authentication is performed on the basis of the handwritten signature registration data 1203 identified by the handwritten signature identification data (ID=0103). If the authentication is successful, the operation permission unit 411 grants permission of printing of the document defined by the handwritten signature registration data 404. Subsequently, the scanned document storage unit 419 stores the scanned document together with the extracted handwritten signature and/or the operation permission information. Although in the present embodiment, the handwritten signature is removed from the scanned document, and the resultant document including no handwritten signature is stored, the scanned document may be directly stored without removing the handwritten signature.

Furthermore, in the handwritten signature similarity evaluation in step S1307, the similarity level of the handwritten signature may be determined, and the processes permitted to be performed may be changed depending on the similarity level. When the similarity level is high, for example, transmission to the outside of a company is permitted. On the other hand, when the similarity level is low, for example, transmission is permitted only within the company.

Now, a third embodiment is described. In this third embodiment, a handwritten signature is input online by using a pen 204 on the operation panel 203 of the multifunction apparatus 202 shown in FIG. 2, and the input handwritten signature is verified for authentication.

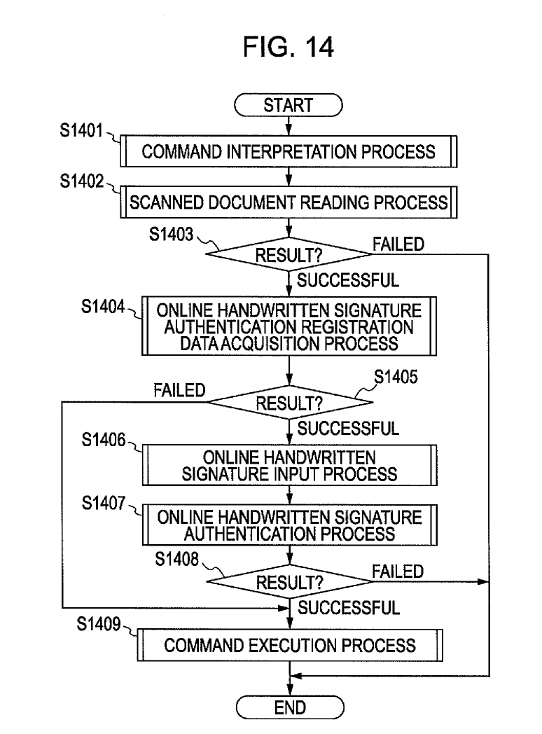

FIG. 14 is a flow chart showing a process of executing an operation specified by an input command according to the third embodiment of the present invention. First, in step S1401, a command input via an operation command input screen is interpreted. Next, in step S1402, a scanned document specified, by the command, to be processed is read. If it is determined in step S1403 that the scanned document has not been read successfully, processing ends. On the other hand, if it is determined in step S1403 that the scanned document has been read successfully, then in step S1404, online handwritten signature registration data is acquired from an online handwritten signature authentication registration database. If it is determined in step S1405 that the acquisition is successful, then in step S1406, a handwritten signature is input online via an online handwritten signature input screen. Thereafter, in step S1407, the online handwritten signature is verified for authentication using the online handwritten signature registration data. If it is determined in step S1408 that the authentication is not successful, processing ends. On the other hand, if it is determined in step S1408 that the authentication is successful, then in step S1409, the process specified by the command is executed. In the case in which it is determined in step S1405 that no online handwritten signature registration data is found, the process specified by the command is executed without performing the authentication of the online handwritten signature.

In an alternative example according to the third embodiment, handwritten signatures 1205 (FIG. 12) used as online handwritten signature registration data are replaced with online handwritten signature information.

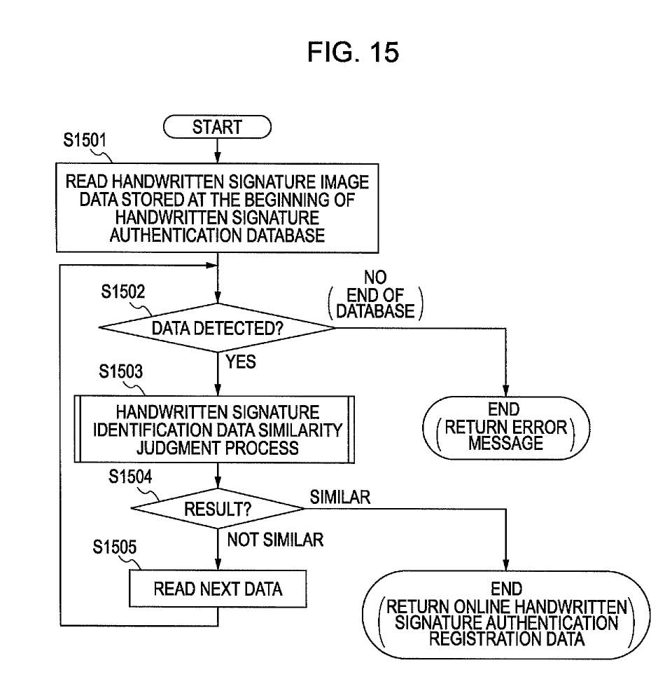

FIG. 15 is a flow chart showing a process of acquiring online handwritten signature authentication data according to the third embodiment of the present invention. First, in step S1501, first data of the online handwritten signature authentication database is read. If it is determined in step S1502 that a handwritten signature registered in the online handwritten signature authentication database has not been detected, processing ends by returning an error message. On the other hand, if it is determined in step S1502 that a handwritten signature registered in the online handwritten signature authentication database has been detected, then in step S1503, similarity is evaluated with respect to the online handwritten signature registration data. If it is determined in step S1504 that the similarity is high, the current online handwritten signature registration data is returned and the present process is ended. On the other hand, in the case in which it is determined in step S1504 that the similarity is low, the process proceeds to step S1505 to read next online handwritten signature registration data. Thereafter, the processing flow returns to step S1502 to repeat the process from step S1502.

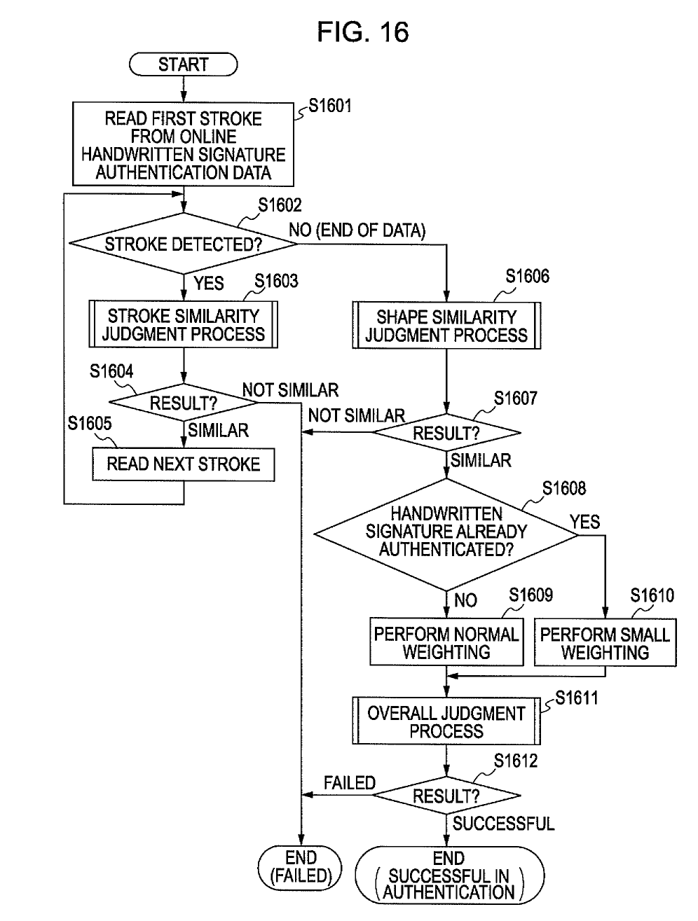

Weighting in the handwritten signature authentication and the online handwritten signature authentication is described below. FIG. 16 is a flow chart showing an online handwritten signature authentication process according to the third embodiment. First, in step S1601, a first stroke is read from online handwritten signature authentication data. If it is determined in step S1602 that the first stroke has been found, then in step S1603, a stroke similarity judgment is performed. More specifically, in this stroke similarity judgment process, the stroke is evaluated to determine whether it is similar to that of the online handwritten signature registration data within a predetermined tolerance. If it is determined in step S1604 that the similarity is not high enough, a negative answer to the authentication is returned, and the current process is ended. On the other hand, if it is determined in step S1604 that the similarity is high enough, then in step S1605, a next stroke is read. The processing flow then returns to step S1602 to repeat the process from step S1602. If all strokes have been determined to have high similarity, and it is determined in step S1602 that there is no more stroke to be checked, then in step S1606, a shape similarity judgment process is performed. If it is determined in step S1607 that the shape similarity is not high enough, a negative answer to the authentication is returned, and the current process is ended. On the other hand, if it is determined in step S1607 that the shape similarity is high enough, then in step S1608 it is determined whether handwritten signature authentication has already been performed. If it is determined that the handwritten signature authentication has already been performed, a weighting factor for the shape in the overall judgment is reduced (step S1610). On the other hand, if it is determined that the handwritten signature authentication has not already been performed, a normal weighting is used (step S1609). Next, the overall judgment is performed in step S1611. After the overall judgment, a result (success or failure) is determined in step S1612 and the process ends (wither with a successful end or a failure end). In the above explanation, for ease of understanding, the evaluation based on strokes and that based on the shape are performed separately. Alternatively, the weighting of the shape may be reflected in the evaluation of strokes.

A specific example of an operation according to the third embodiment is described below. If an online handwritten signature for authentication is input, a command input via the operation panel 203 of the multifunction apparatus 202 is interpreted, and the following process is performed. First, a document specified to be processed is read. The online handwritten signature authentication registration database is then searched using a handwritten signature 205 as a search key to acquire online handwritten signature registration data. Thereafter, a message is displayed to prompt a user to input an online handwritten signature. If the input online handwritten signature is successfully authenticated, the specified operation is allowed to be performed. In a case in which there is no online handwritten signature corresponding to the handwritten signature written on the document, prompting to input the online handwritten signature is not performed.

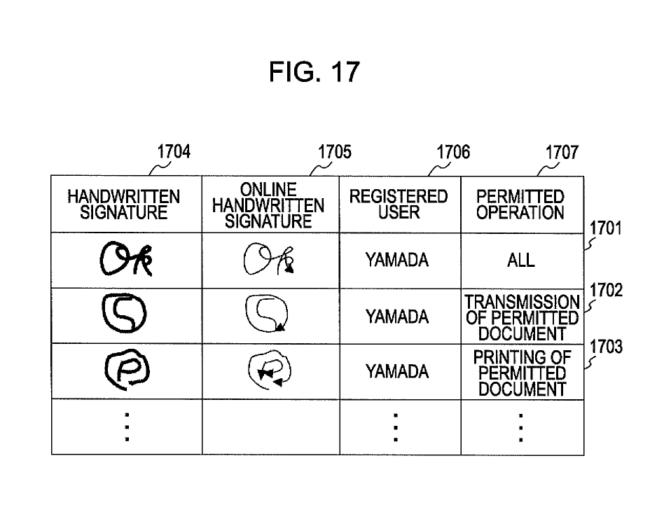

FIG. 17 shows another example of an online handwritten signature authentication registration database according to the third embodiment. This example is different from the previous example in that respective data are registered in connection not with handwritten signature identification data but with handwritten signature images. In each of records 1701 to 1703, a handwritten signature image 1704, an online handwritten signature stroke 1705, a registered user 1706, and a permitted operation 1707 are described.

A specific example of an operation is described below. If a document is set on the multifunction apparatus 202 and a read command is issued, a handwritten signature 1102 written on the document is verified for authentication on the basis of handwritten signature registration data 1103 extracted from the document. If the authentication is performed successfully, the online handwritten signature registration data acquisition unit 311 acquires online handwritten signature registration data in which a handwritten signature similar to the handwritten signature is registered, and the process is executed. In this example, as described above, instead of embedding handwritten signature identification data, handwritten signature registration data is embedded in each document to achieve effects similar to those achieved in the previous example.

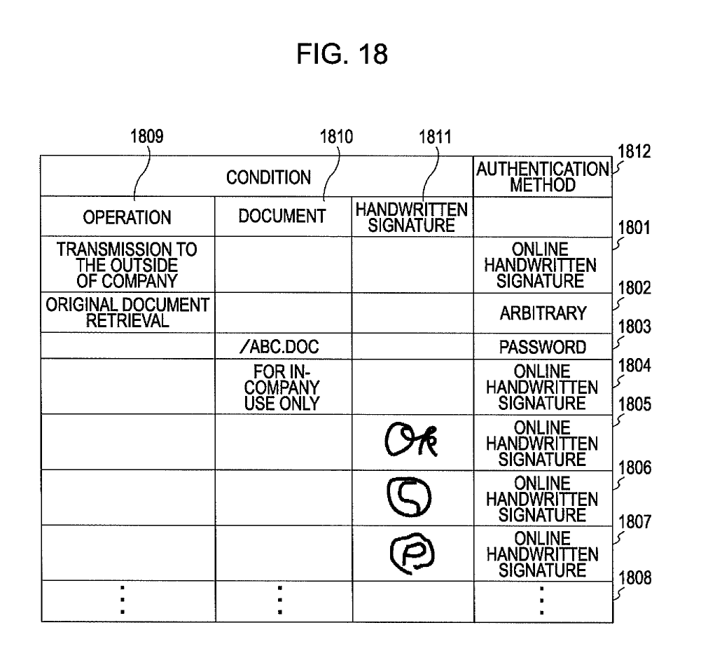

Now, with reference to FIG. 18, a fourth embodiment is described. In this fourth embodiment, a user is prompted, as required, to input data for second authentication in addition to the authentication based on the handwritten signature written on a document.

First, an example is explained in which a password is input for second authentication. In this example, in the flow chart shown in FIG. 7, if it is determined in step S705 that the authentication failed, a password input screen is displayed on the operation panel 203 shown in FIG. 2 to prompt a user to input a password. If the password is successfully authenticated, then in step S706, permission of an operation is granted. However, if the authentication failed, the process is ended.

FIG. 18 shows an example of a rule of necessity of second authentication according to the fourth embodiment. In this specific example, in each of records 1801 to 1808, an authentication method 1812 is defined for an operation 1809, a document 1810, and a handwritten signature 1811.

For example, when a command to register a second authentication necessity rule is input as an operation command in step S603 shown in FIG. 6, a process of registering a second authentication necessity rule is executed. If the process of registering the second authentication necessity rule is completed, the processing flow returns to step S602 to repeat the operation.

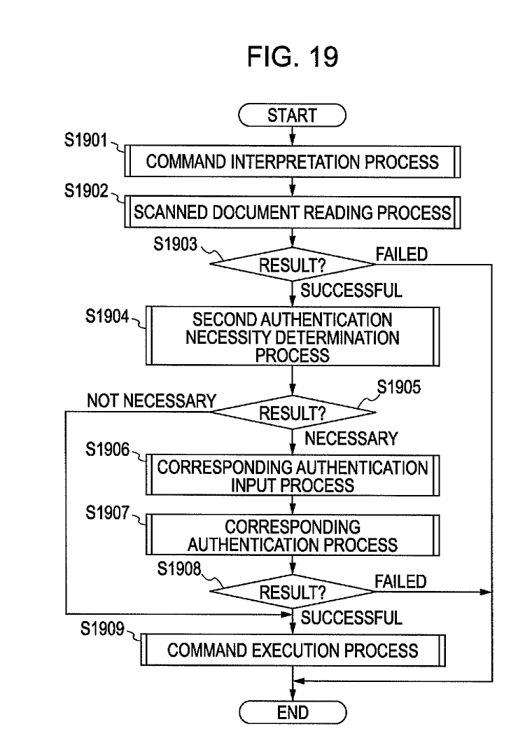

FIG. 19 is a flow chart showing a process of executing an operation specified by an input command according to the fourth embodiment. First, in step S1901, a command input via an operation command input screen shown in FIG. 5 is interpreted. Next, in step S1902, a scanned document specified, by the command, to be processed is read. If it is determined in step S1903 that the scanned document has not been read successfully, processing ends. On the other hand, if it is determined in step S1903 that the scanned document has been read successfully, then in step S1904, it is determined whether second authentication is necessary. If it is determined in step S1905 that the second authentication is necessary, then in step S1906, data for the second authentication is input via an authentication input screen according to the second authentication necessity rule. In step S1907, authentication is performed. If it is determined in step S1908 that the authentication is not successful, processing ends. On the other hand, if it is determined in step S1908 that the authentication is successful, then in step 1909 the process specified by the command is executed. On the other hand, if it is determined in step S1905 that the second authentication is not necessary, the process specified by the command is executed without performing the second authentication.

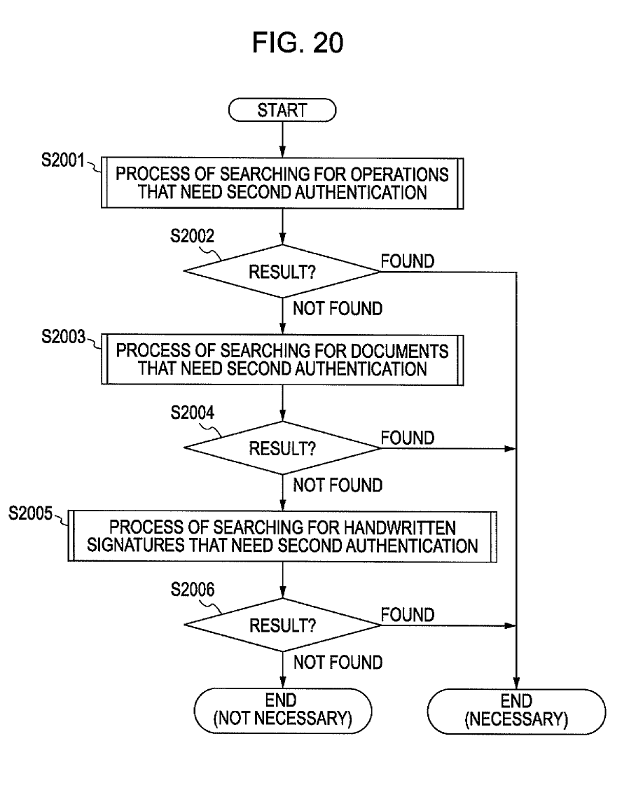

FIG. 20 is a flow chart showing a second authentication necessity determination process according to the fourth embodiment. First, in step S2001, the second authentication necessity rule described above with reference to FIG. 18 is examined to determine whether a second authentication is defined which is necessary to execute a requested operation. If it is determined in step S2002 that the second authentication is necessary, information indicating that the second authentication is necessary is returned, and the present process is ended. In step S2003, the second authentication necessity rule is examined to determine whether the current document needs second authentication. In step S2005, the second authentication necessity rule is examined to determine whether the current handwritten signature needs further second authentication.

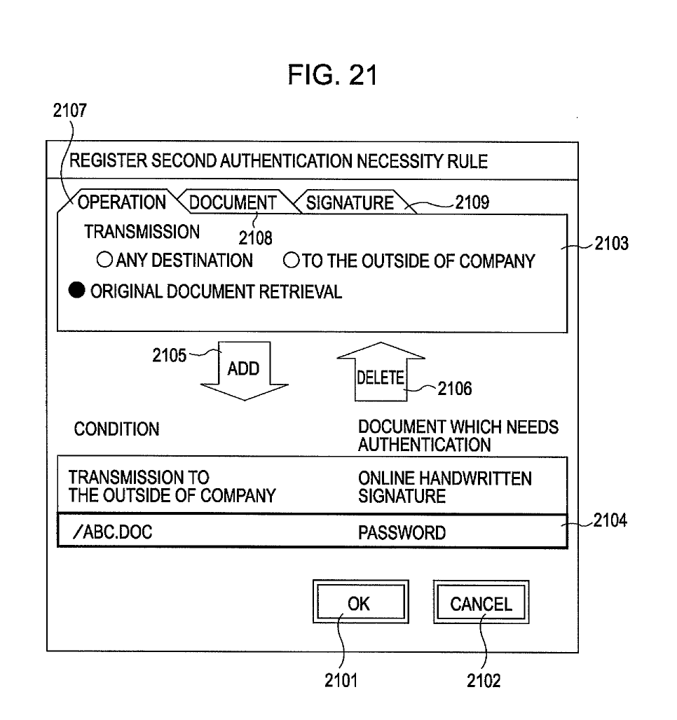

FIG. 21 shows an example of a second authentication necessity rule registration screen displayed on the operation panel 203 of the multifunction apparatus 202 according to the fourth embodiment. This screen includes an OK button 2101, a CANCEL button 2102, a box 2103 for specifying conditions that need second authentication, a box 2104 for displaying an already registered second authentication necessity rule, and an ADD button 2105 which is clicked to add a new second authentication necessity rule. The screen also includes a DELETE button 2106 which is clicked to delete a second authentication necessity rule, an OPERATION tab 2107 to select a box for defining operations that need second authentication, a DOCUMENT tab 2108 to select a box for defining documents that need second authentication, and a SIGNATURE tab 2109 to select a box for defining handwritten signatures that need second authentication.

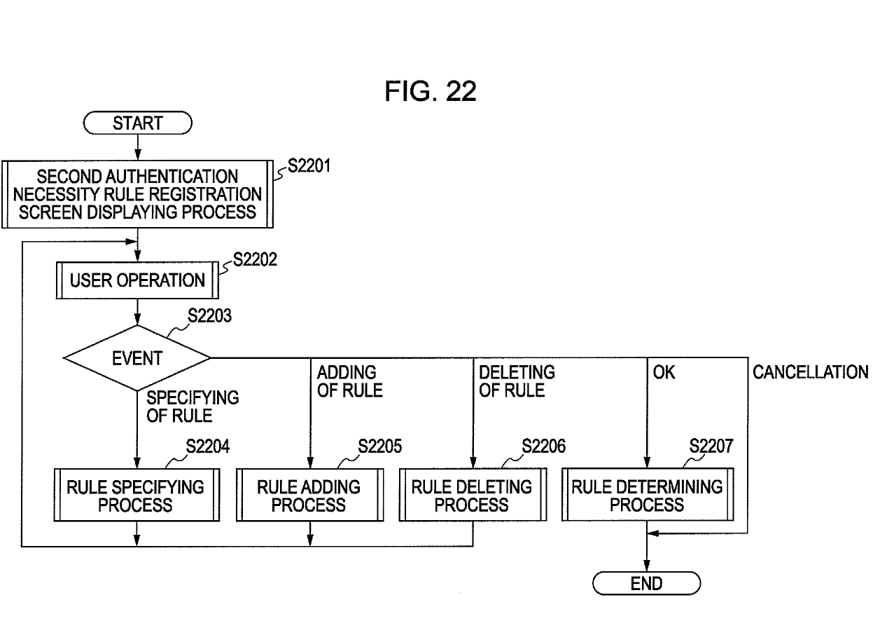

FIG. 22 is a flow chart showing a second authentication necessity rule registration process according to the fourth embodiment. First, in step S2201, the second authentication necessity rule registration screen (FIG. 21) is displayed. Next, in step S2202, a user performs an operation. Next, in step S2203, the process flow branches depending on the operation performed in step S2202 by the user. If it is determined in step S2203 that a rule specifying command has been input, then in step S2204, a rule is specified according to the input rule specifying command. The processing flow then returns to step S2202 to repeat the process from step S2202. In a case in which it is determined in step S2203 that a rule add command has been input, the process proceeds to step S2205 to add a specified rule. The processing flow then returns to step S2202 to repeat the process from step S2202. On the other hand, if it is determined in step S2203 that a rule delete command has been input, the process proceeds to step S2206 to delete a specified rule. The processing flow then returns to step S2202 to repeat the process from step S2202. If it is determined in step S2203 that the OK button has been pressed, then in step S2207, the specified rule is finally determined, and the present process is ended. However, if it is determined in step S2203 that the CANCEL button has been pressed, the specified modification of the rule is cancelled, and the present process is ended.

With reference to the figures used in the above explanation, a specific example of an operation is described below. For example, if the operation command 1809 issued by a user is a command to transmit a document to the outside of a company, a second authentication necessity rule 1801 is applied, and thus the user is prompted to input an online handwritten signature. In a case in which an original command retrieval command is issued as the operation command 1809, a second authentication necessity rule 1802 is applied, and thus a user is prompted to input data for second authentication according to an arbitrary authentication method. The arbitrary authentication method may be defined by default in the system, or may be set for each user. On the other hand, for example, when the original document is “/ABC.DOC”, a second authentication necessity rule 1803 is applied, and a user is prompted to input a password. In the case of an original document specified as “for in-company use only”, a second authentication necessity rule 1804 is applied, and thus a user is prompted to input an online handwritten signature. In the case in which a handwritten signature is written on a document, a second authentication necessity rule 1805, 1806, or 1807 is applied, and the user is prompted to input an online handwritten signature.

In the present embodiment, as described above, a most proper authentication method is selected as required.

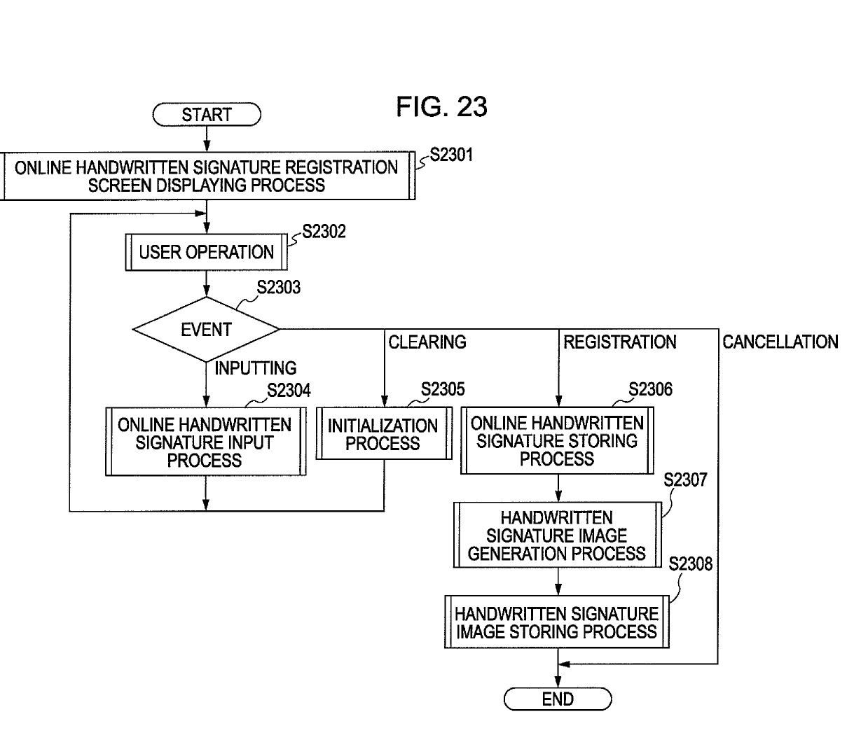

Now, referring to FIG. 23, a fifth embodiment is described. In this fifth embodiment, when an online handwritten signature is registered, the online handwritten signature is automatically registered as a handwritten signature. A registration screen used herein in the fifth embodiment is similar to the operation panel 203 shown in FIG. 2 except that it further includes a REGISTRATION button, a CANCEL button, and a CLEAR button.

Note that the process according to this fifth embodiment is executed when it is determined in step S603 in FIG. 6 that the operation performed by a user is inputting a command to register an online handwritten signature. If the online handwritten signature registration process is completed, the processing flow returns to step S602 to repeat the process from step S602.

FIG. 23 is a flow chart showing an online handwritten signature registration process according to the fifth embodiment. First, in step S2301, an online handwritten signature registration screen is displayed. Next, in step S2302, a user performs an operation. Next, in step S2303, the process flow branches depending on the operation performed by the user in step S2302. If it is determined in step S2303 that an inputting operation has been performed by the user, then in step S2304, a stroke of an online handwritten signature is input. Thereafter, the processing flow returns to step S2302 to repeat the process from step S2302. On the other hand, if it is determined in step S2303 that a clear command has been input, then in step S2305, online handwritten signature strokes which have been input by the present time are cleared. The processing flow then returns to step S2302 to repeat the process from step S2302. If it is determined in step S2303 that the registration button has been pressed, then in step S2306, input online handwritten signature strokes are stored. Subsequently, in step S2307, a handwritten signature image is generated from the online handwritten signature strokes stored in step S2306. In step S2308, the resultant handwritten signature image is stored, and the process is ended. In a case in which it is determined in step S2303 that the CANCEL button has been pressed, the input command is cancelled, and the present process is ended.

With reference to the figures used in the above explanation, a specific example of an operation is described below. For example, if an online handwritten signature stroke 206 is input, then in step S2307, a handwritten signature image is generated from the input online handwritten signature stroke. This makes it unnecessary to separately to input the handwritten signature in addition to the online handwritten signature.

In the present embodiment, as described above, the handwritten signature is generated from the online handwritten signature registration data, and thus it becomes unnecessary to separately register the handwritten signature.

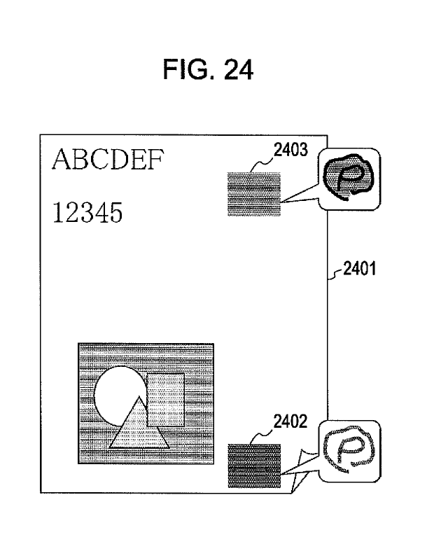

Referring to FIGS. 24 to 26, a sixth embodiment is described. In this sixth embodiment, a handwritten signature written on a document is embedded in the document.

If the EMBED button 508 shown in FIG. 5 is clicked as a user operation in step S603, then, as shown in FIG. 24, a handwritten signature written on a document is displayed in the form of a two-dimensional bar code 2403 distinguishable from the other area.

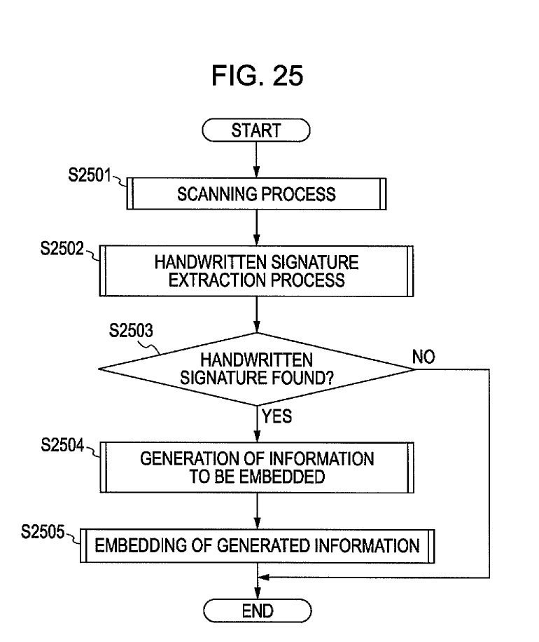

FIG. 25 is a flow chart showing a handwritten signature embedding process according to the sixth embodiment. First, in step S2501, a given document is read by scanning the document. Subsequently, in step S2502, a handwritten signature written 2402 on the scanned document is extracted. If it is determined in step S2503 that the handwritten signature has not been successfully extracted, processing ends. On the other hand, if it is determined in step S2503 that the handwritten signature has been successfully extracted, then in step S2504, information of the extracted handwritten signature to be embedded in the document is generated. Subsequently, in step S2505, the generated information is embedded in the document.

As described above, the handwritten signature written on the document can be generated in the form of the two-dimensional bar code 2403 embeddable in the document. This makes it possible to incorporate information equivalent to the handwritten signature in the document in a form that prevents the shape of the handwritten signature from being exposed to third persons, thus high security is achieved.

In the present embodiment as described above, data of a registered online handwritten signature or data identifying such data is embedded in a document, thereby achieving high security.

0] The present invention may be applied to a singly-installed independent apparatus (such as a copy machine, a facsimile machine, etc.) or a system including a plurality of apparatuses (such as a system including a host computer, an interface device, a reader, a printer, etc.).

A storage medium such on which a software program code for implementing one or more functions according any embodiment described above may be supplied to the system or the apparatus. The functions of the present invention can be achieved by reading the program code from the storage medium and executing it on a computer (or a CPU or an MPU) disposed in the system or the apparatus.

In this case, the program code read from the storage medium implements the functions disclosed in the embodiments described above, and the storage medium on which the program code is stored falls within the scope of the present invention.

Specific examples of storage media which can be employed in the present invention to supply the program code include a floppy disk, a hard disk, an optical disk, a magneto-optical disk, a CD-ROM disk, a CD-R disk, a magnetic tape, a non-volatile memory card, and a ROM.

The functions disclosed in the embodiments may be implemented not only by executing the program code on a computer, but part or all of the process may be performed by an operating system (OS) or the like running on the computer in accordance with the program code. Such implementation of the functions also falls within the scope of the present invention. To implement one or more functions according to any of the above-described embodiments of the invention, the program stored on a storage medium may be loaded into a memory of a function expansion board inserted in a computer or into a memory of a function expansion unit connected to the computer. In this case, part or all of the process may be performed by a CPU disposed on the function expansion board or the function expansion unit in accordance with the loaded program code. Such implementation of the functions also falls within the scope of the present invention. More specifically, when the present invention is applied to the storage medium, program code corresponding to processes defined in the flow charts described above with reference to the figures is stored in the storage medium.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2006-032503 filed Feb. 9, 2006, which is hereby incorporated by reference herein in its entirety.

What is claimed is:

1. An information processing apparatus comprising:
a scanning unit adapted to scan a document on which a signature is handwritten;
a handwritten signature extraction unit adapted to extract the handwritten signature from the scanned document scanned by the scanning unit;
a handwritten signature authentication unit adapted to authenticate the handwritten signature extracted by the extraction unit, based on authentication information; and
a permission unit adapted to, if the handwritten signature is successfully authenticated by the handwritten signature authentication unit, grant permission of a process on the scanned document.

2. The information processing apparatus according to claim 1, further comprising an output unit adapted to output the scanned document scanned by the scanning unit,
wherein the output unit is adapted to output a document obtained by deleting the handwritten signature extracted by the extraction unit from the scanned document scanned by the scanning unit.

3. The information processing apparatus according to claim 1, further comprising a recognition unit adapted to recognize a restriction on a process on the scanned document,
wherein the permission unit is adapted to grant permission of the process, which has been recognized by the recognition unit as being restricted for the scanned document, on the scanned document.

4. The information processing apparatus according to claim 1, further comprising a storage unit,
wherein the authentication information is information including handwritten signature information and user information stored in advance in the storage unit, in a form in which the handwritten signature information and the user information are related to each other, and
the handwritten signature authentication unit is adapted to check similarity between the handwritten signature extracted by the extraction unit and the handwritten signature information in the authentication information, and positively authenticates the handwritten signature when it is determined that the similarity is high.

5. The information processing apparatus according to claim 1, further comprising an authentication information extraction unit adapted to extract authentication information necessary for authentication, from the document,
wherein the handwritten signature authentication unit performs the authentication using the authentication information.

6. The information processing apparatus according to claim 5, wherein
the authentication information is handwritten signature information from which the handwritten signature is reproducible, and
the handwritten signature authentication unit is adapted to check similarity between the handwritten signature extracted by the extraction unit and the handwritten signature reproduced from the handwritten signature information, and positively authenticates the handwritten signature extracted by the extraction unit when it is determined that the similarity is high.

7. The information processing apparatus according to claim 5, wherein
the authentication information is identification information that identifies a handwritten signature from a database in which handwritten signatures are stored in advance in one-to-one connection with identification information,
wherein the handwritten signature authentication unit is adapted to check similarity between the handwritten signature extracted by the extraction unit and the handwritten signature identified by the identification information, and positively authenticates the handwritten signature extracted by the extraction unit when it is determined that the similarity is high.

8. The information processing apparatus according to claim 1, further comprising an online handwritten signature input unit,
wherein the handwritten signature authentication unit is adapted to check similarity between the handwritten signature extracted by the extraction unit and a handwritten signature input via the online handwritten signature input unit, and positively authenticates the handwritten signature extracted by the extraction unit when it is determined that the similarity is high.

9. The information processing apparatus according to claim 4, wherein the process permitted by the permission unit varies depending on the similarity level determined by the handwritten signature authentication unit.

10. The information processing apparatus according to claim 7, further comprising a handwritten signature registration unit adapted to register, as a handwritten signature, an online handwritten signature input via the online handwritten signature input unit.

11. The information processing apparatus according to claim 1, further comprising an embedding unit adapted to embed information associated with the handwritten signature extracted by the extraction unit into the document scanned by the scanning unit.

12. The information processing apparatus according to claim 1, wherein the process permitted by the permission unit is at least one of printing, transmission, displaying, and original document searching.

13. A method of controlling an information processing apparatus, comprising:
scanning a document on which a signature is handwritten;
extracting the handwritten signature from the scanned document scanned;
authenticating the handwritten signature extracted, based on authentication information; and
if the handwritten signature is successfully authenticated, granting permission of a process on the scanned document.

14. A computer program implementing a method of controlling an information processing apparatus, the computer program being readable and executable by the information processing apparatus, the method implemented by the computer program comprising:
scanning a document on which a signature is handwritten;
extracting the handwritten signature from the scanned document;
authenticating the handwritten signature extracted, based on authentication information; and
if the handwritten signature is successfully authenticated, granting permission of a process on the scanned document.

15. A method of controlling an information processing apparatus, comprising:
scanning a document on which a signature is handwritten;
extracting the handwritten signature from the scanned document; and
granting permission of a process on the scanned document, in accordance with a result of authentication performed, based on authentication information, for the handwritten signature extracted.
